(19) United States
(12) Patent Application Publication
(10) Pub. No.: US 2023/0243410 A1
(43) Pub. Date: Aug. 3, 2023

(54) Globular Right-Angle Gearbox

(71) Applicant: Benyamin Akbari Rostami, Vancouver (CA)

(72) Inventor: Benyamin Akbari Rostami, Vancouver (CA)

(21) Appl. No.: 17/590,731

(22) Filed: Feb. 1, 2022

(51) Int. Cl. F16H 55/17; F16H 1/22

(52) U.S. Cl. CPC F16H 55/17; F16H 1/222; F16H 2055/173

(57) ABSTRACT

Globular right-angle gearbox consists of two new types of gear that the body encloses them in the shape of a globe. Main gear 1 and flower gear 2 are created from parts of a hypothetical sphere. The new idea of using a diagonal axis causes two flower gears 2 to rotate in one direction by one main gear 1. And for the rotation of the main gear 1 with a diagonal axis, the idea of two gears with different diameters inside each other has been used. The centrality of the input and output shafts, simultaneously changes direction and ratio of the input force, the spherical shape and the multiplicity of effective variables in the design of this gearbox are its unique advantages. These unique properties of this gearbox make it applicable in many cases, including the joints of robot limbs, as well as the joints of human artificial limbs.

### BACKGROUND OF THE INVENTION

All of the right-angle gearbox has two axes which are not the center and this cause most of them have the shape unbalanced that caused the body of those are bigger than necessary or they have a body unbalanced. But the components of this gearbox are put together in such a way that they form a complete sphere, and this feature makes this gearbox have many uses. This gearbox can be used in all joints of robots and joints of artificial arms and legs as well. This gearbox has a main 1 gear that rotates both flower 2 gears in the same direction. All gears rotate by their own axis, which is perpendicular to the gear plane, but in this gearbox the main gear 1, despite the diagonal axis, constantly rotates on a plane.

### SUMMARY OF THE INVENTION

There are several new ideas in making this device, which makes this device very practical and beneficial including:
The input and output shafts are concentric.
Globular shape of the gearbox.
Rotate in the same direction as two flower gears 2 engaged with one main gear 1 by using the angle deflection on the new plane.
Using the convertor gear 3 with the diameter smaller than the inner gear of the main gear 1 for the main gear 1 rotation with a diagonal axis.
The new type of gear that made from the biggest slice of a hypothetical sphere main gear 1.
The new type of gear that made from the shell segments of a hypothetical sphere, flower gear 2.

Input force is transmitted to the convertor gear 3 by the input shaft, the convertor gear 3 has two contact points with the inner gear of the main gear 1 and through them transmits force to it, while maintaining the angle of the main gear 1. Due to the deflection angle of the main gear 1, the main gear 1 teeth 8 are engaged with them at two points of each flower gear 2, but the engagement points of each flower gear 2 are opposite side of each other from the plane x-y that causes the flower gears 2 to rotate in the same direction. The force after change direction and ratio transmitted to the consumer through output shafts of the flower gears 2.

### BRIEF DESCRIPTION OF THE DRAWINGS

FIG. 1 It is the schematic drawing to show coordinate system of the axes and the planes.

FIG. 2 it is the four views of the main gear 1.

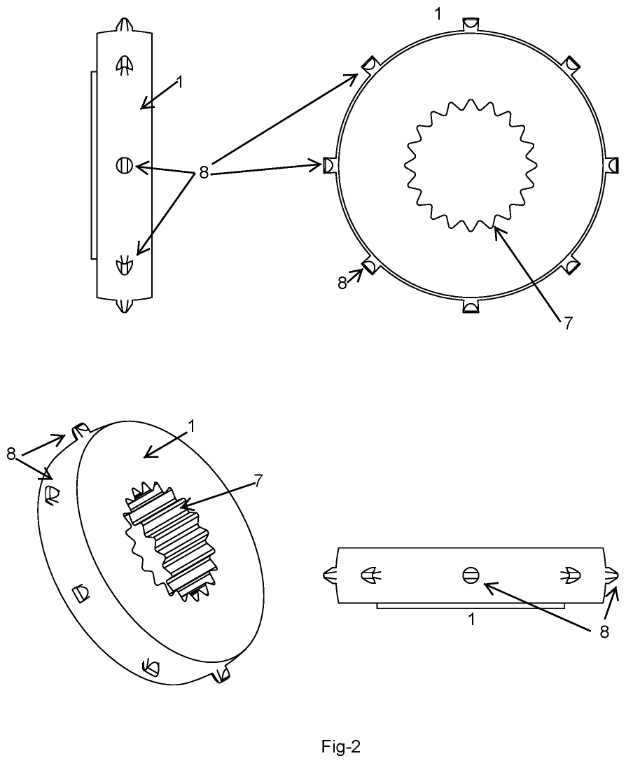

FIG. 3 it is the four views of the flower gear 2.

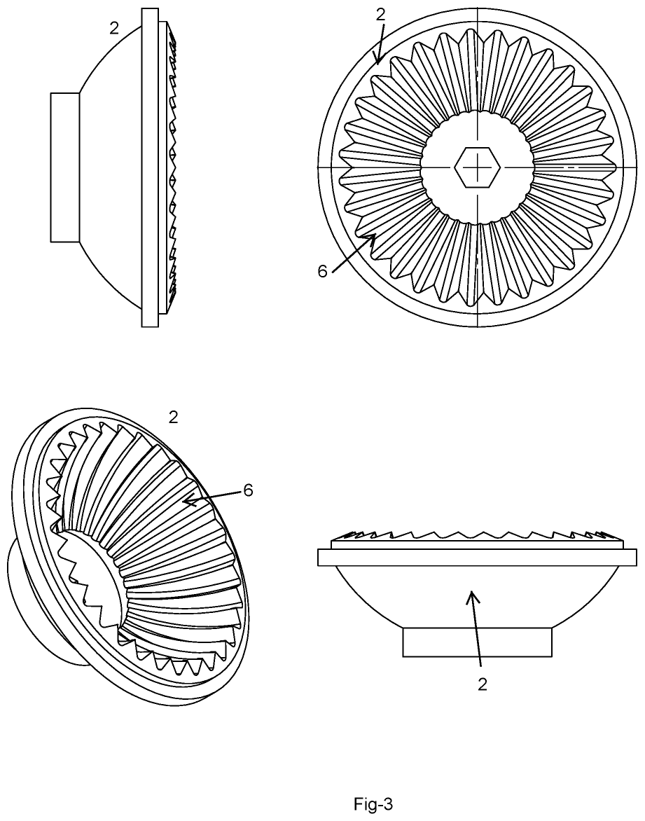

FIG. 4 it is the four views of the convertor gear 3.

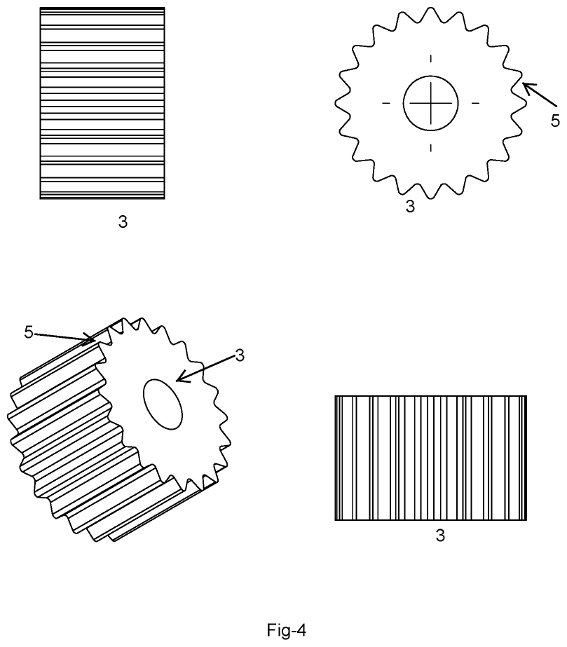

FIG. 5 it is the four views of body 4.

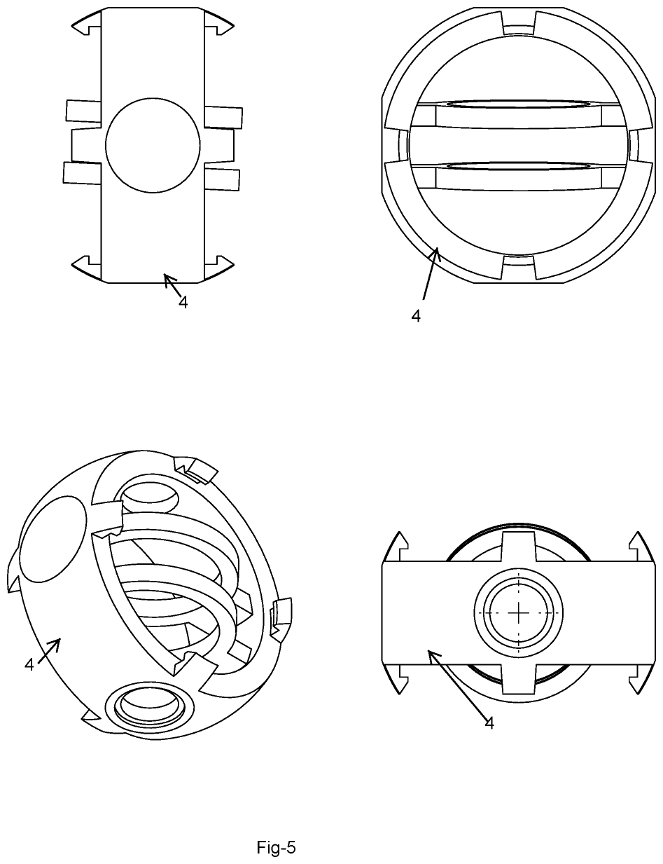

FIG. 6 it is the four views of the assembled device.

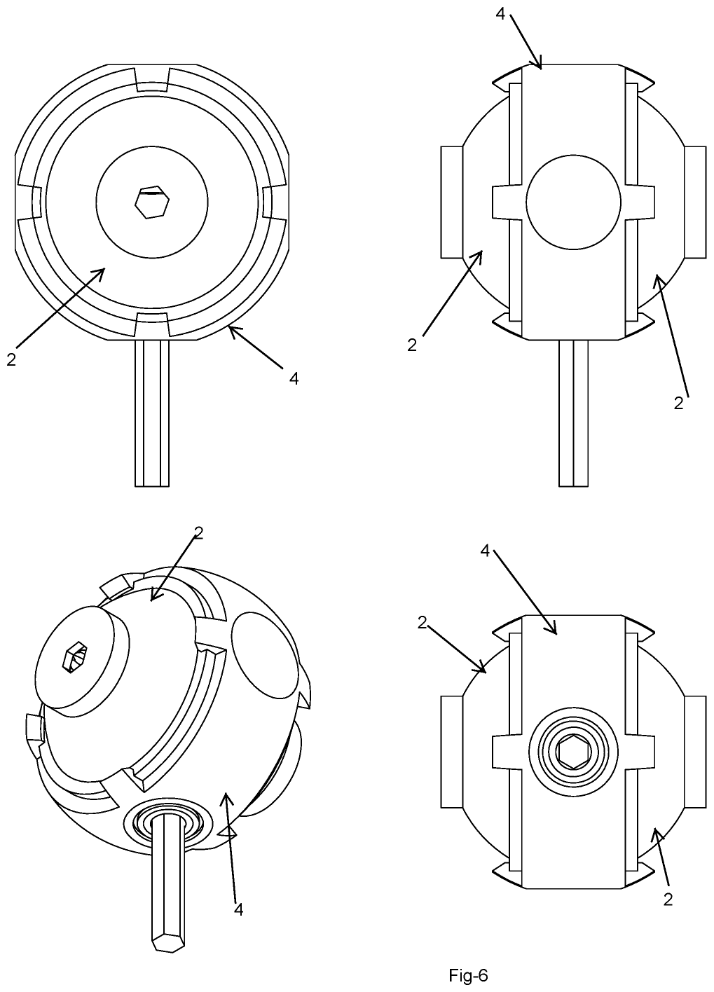

FIG. 7 it is the four views of the device in explode situation and its section and its detail.

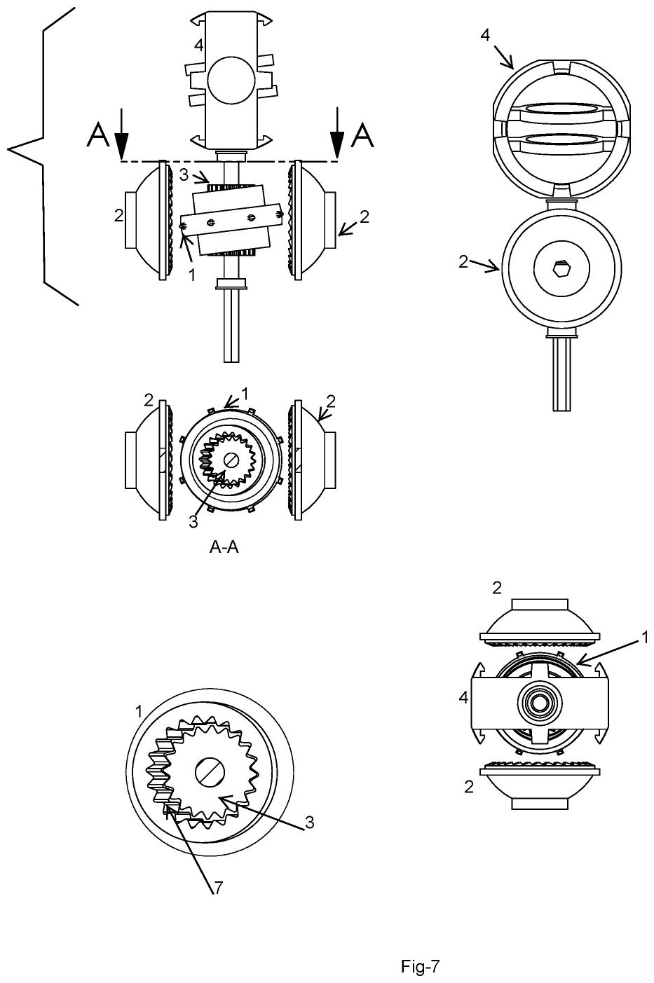

FIG. 8 it is the four views of the process of the create the flower gear 2 in 45-degree segments.

FIG. 9 it is the four views of the process of the create the flower gear 2 in 22.5-degree segments.

FIG. 10 a-g is seven schematic drawing to describe clearer of the process of the design of the device.

### DESCRIPTION OF THE INVENTION

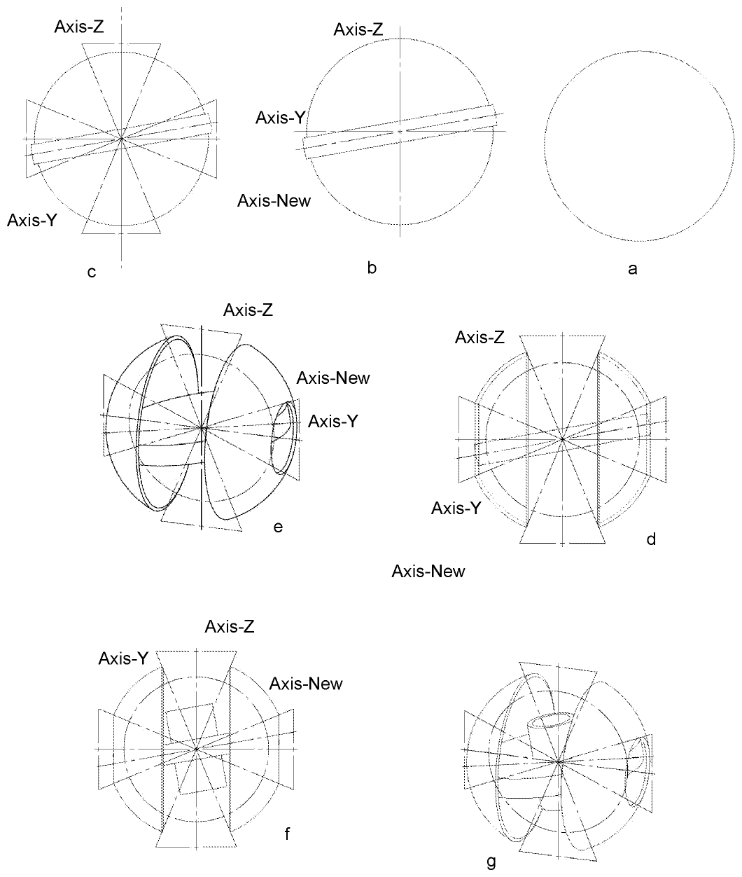

To design of this gearbox, proportion to the application of the device is considered a sphere with specified diameter (FIG. 10a). This hypothetical sphere is only for the better visualization to describe the device and its components and their positions. And by considering this hypothetical sphere during the design time, the sizes and positioning of the components are designed better and easily. And whole of the components, axes and planes of this device are in accordance with the imaginary sphere coordinate system, that considering a hypothetical sphere corresponding to this coordinate system is a suitable means for describing and designing the device. Therefore. first imagine a hypothetical sphere with three axes X, Y and Z and three planes X-Y, X-Z and Y-Z. The input shaft corresponds to the Z-axis and the output shafts correspond to the Y axis. There is another plane with a certain angle to the plane X-Y, which is called the new plane here (FIG. 10b). The angle between the new plane and the plane X-Y is one of the design parameters of this device. Perpendicular to this new plane there is an axis, which is called new axis here. All of the center of the planes corresponds to the center of the coordinate system of the hypothetical sphere.
The flower gear 2 is in the form of a shell of a sphere, whose center is corresponded to it, and its plane is corresponded to the plane X-Z. The rotational axis of the flower gears 2 are corresponded to the Z-axis. In this device always, two flower gears 2 are used that are completely identical (FIG. 10d).
The convertor gear 3 is a long gear that its axis is corresponded to the Z-axis.
The body 4 of device is in the form of a hollow sphere that maintains all of the components and axes in their designed positions. When the components of the device are placed together, they almost form the shape of a sphere, and the body 4 which is in the shape of a hollow sphere, covers them.
   By the operating of this device, the rotational force of the input shaft is applied to the output shafts with a suitable ratio of the torque and speed according to the design. Of course, with this process the rotation force of the input shaft is transmitted to the output shaft that are perpendicular each other.
   When the components of the device are placed together, there is less empty and useless space than similar devices. In other words, this gearbox is a compact device.
   The new idea of the working mechanism of this device is to use a diagonal rotation axis for the main gear 1. With this mechanism, the main gear 1 engages with the flower gears 2 in the opposite sides of each other from the plane X-Y (FIG. 10f,g). As a result of the rotation of the main gear 1, the input rotational force transmitted to the flower gears and they in their planes that are parallel with the plane X-Z rotate. Therefore, the input rotational force is transmitted to the output rotational axes with ninety degrees change.
   The new idea of the use in this

This gearbox consists of the following main components:
The main gear 1:
   Main gear 1 is shaped like the biggest slice of a sphere with the specific number of teeth 8 on its surface.
   The center plane of the main gear 1 corresponds to the new plane.
   The rotation axis of the main gear 1 corresponds to the new axis.
   Main gear 1 has an inner gear in its center.
   The main gear 1 has two engagement points with each flower gear 2.
   Engagement points of the main gear 1 with the flower gears 2 are located at the opposite their sides from the plane X-Y.
   The main gear 1 axis has a specific angle difference with the Z-axis, the value of which is based on the design.
The flower gear 2:
   The flower gear 2 is shaped like part of the shell of a sphere which inside of that a number of uniform grooves 6 are designed.
   The rotation axis of the flower gear 2 corresponds to the Y-axis.
   The output shaft corresponds to the flower gear 2 axis.
   In this gearbox always two flower gears 2 is used.
The convertor gear 3:
   The convertor gear 3 is a long gear that engages with the inner gear of the main gear 1 at two points.
   The axis of the convertor gear 3 corresponds to the Z-axis.
   The input shaft corresponds to the axis of the convertor gear 3.
The body 4 has a structure to hold of the:
   Rotation axis of the main gear 1 that consistent to the new axis.
   The rotation axes of the flower gears 2 that consistent to the Y-axis.
   The rotation axis of the convertor gear 3 that consistent to the Z-axis.
   Other types of body 4 design are acceptable as long as these conditions are met.
Other accessories that are commonly found in such devices, such as ball bearings, shafts and so on.

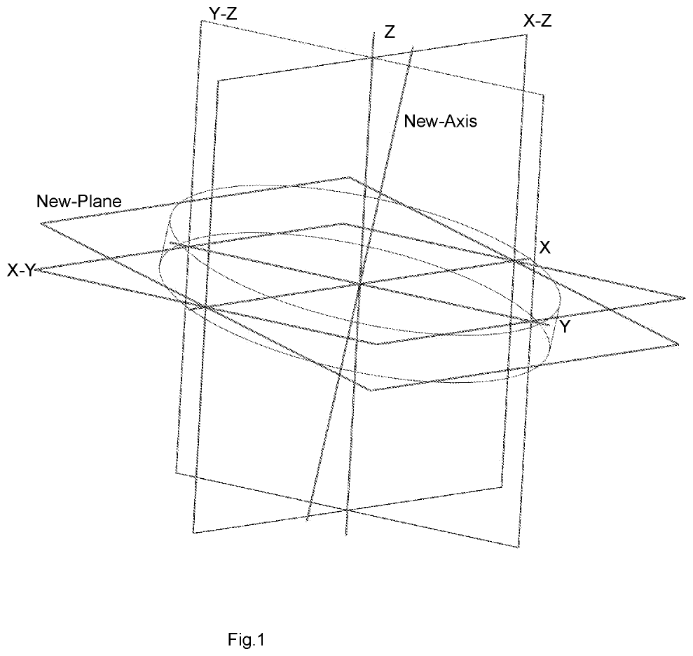

The main gear 1 is the biggest slice of the hypothetical sphere that corresponds to the new plane and the new axis passes through the center of the main gear 1 (FIG. 1). Main gear 1 has a number of teeth 8, the number of which depends on the design of the flower gear 2. The thickness of the main 1 gear is proportional to the condition of the teeth 8 of the main gear 1. The specific number of teeth 8 are placed on the surface of the main gear 1 with specific position so that the angles between them are equal, according to the design. There is an inner gear in the center of the main gear 1 that has two engagement points with the convertor gear 3. Due to the angle difference between the axis of the inner gear of the main gear 1 and the axis of the convertor gear, there are these two engagement points for them. In other hand because of the angle between the center plane of the main gear 1 and the plane X-Y, the teeth 8 of the main gear 1 engage with two grooves 6 of each flower gear 2. The engagement points of each flower gear 2 are on the opposite side of the other flower gear with respect to the plane X-Y.

The flower gear 2 is in the form of a part of the shell of the hypothetical sphere which is parallel to the plane Z-Y and the Y-axis passes through both flower gears 2 and the output shafts apply to these flower gears 2. The flower gear 2 has a number of uniform grooves 6 which its specification is determined during the design in accordance with the function of the gearbox. For each gearbox always two flower gears 2 used which, both of them are exactly the same and located both side of the main gear 1 and engaged with that at the four points, two points for each flower gear 2. These engagement points are at the opposite side of each other with respect to the plane X-Y (Fig. g).

The convertor gear 3 is a long gear whose principal task is to rotate the main gear 1 by the force exerted of the input shaft. The convertor gear 3 is required to eliminate the angle difference between the rotational axis of the main gear 1 and the axis of the input shaft.

Convertor gear 3 is located inside the main gear 1 and has two engagement points with the inner gear of the main gear 1 which rotate the main gear 1.

Diameter of the inner gear of the main gear 1, diameter of the convertor gear 3, the length of the convertor gear 3, pitch and the number of the teeth 5 of the convertor gear 3 are the variables of the design of the inner gear of the main gear 1 and convertor gear 3. Under the influence of these variables, convertor gear 3 and the inner gear of the main gear 1 must be designed in such a way that they have a strong engagement, provide the desired angle and move smoothly. In this section of gearbox, it is also possible design different ratio by considering the limitations and variables. For example, by changing the diameter or the length of the inner gear of the main gear land the convertor gear 3, the number of teeth 7 of the inner gear of the main gear 1 and the teeth 5 of the convertor gear 3 also change. Therefore, during the design, by considering the appropriate variables, the desired ratio is obtained. But changing this ratio is limited because strong engagement and soft function must always be prioritized for this part first.

The body 4 has a structure that has to hold both flower gears 2 parallel to the plane Z-Y and their axes of rotation on the Y-axis. The body 4 also holds the main gear 1 so that its axis of rotation consistent with the new axis designed with deflection angle. The most important point in designing the body 4 of the gearbox is to maintain the position of the main gear 1, the flower gears 2 and the convertor gear 3 and there are no other restrictions, and all types of design that meet these conditions are acceptable.

The position of the input shaft which passes through the convertor gear 3 to transmit the rotational driving force and thus rotate it, is maintained by two bearings up and down. For smooth and strong engagement between the teeth 7 of the inner gear of the main gear 1 and the teeth 5 of the convertor gear 3, effective variables must be used to create these conditions.

To Make this Gearbox:

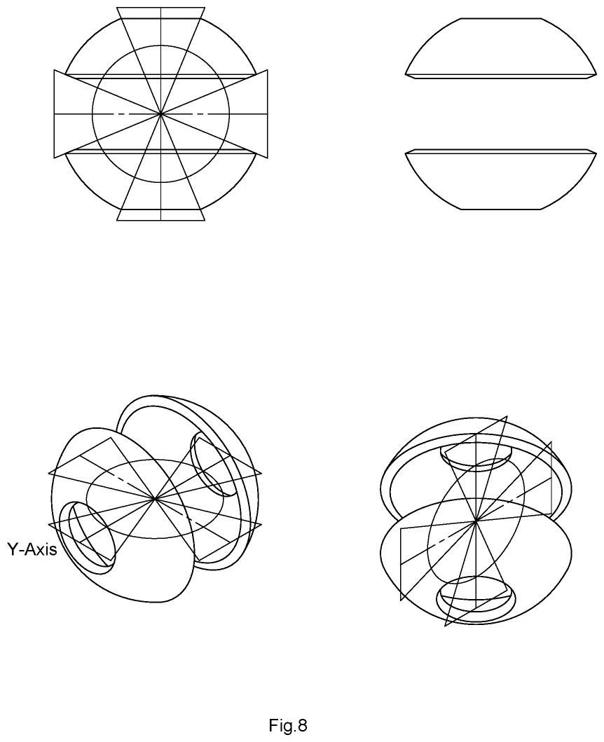

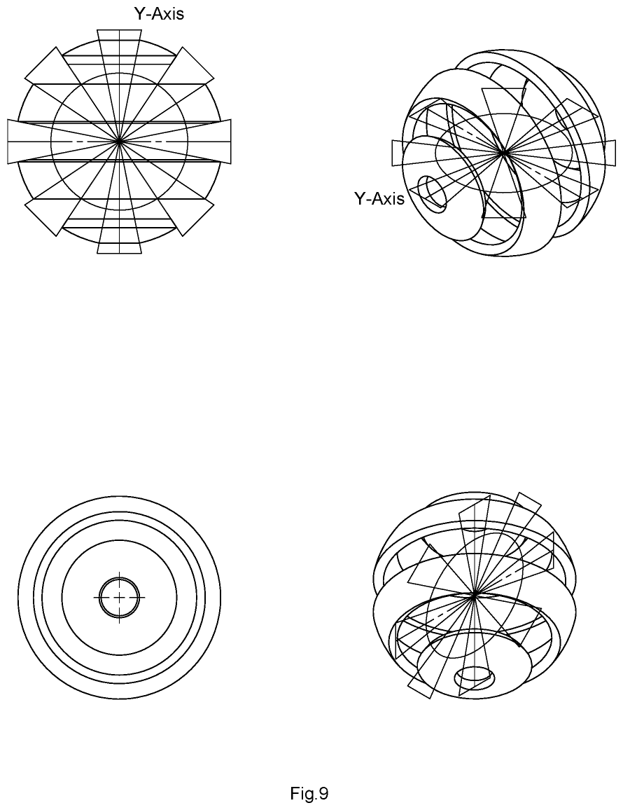

To design and build this gearbox, the main gear 1, the flower gear 2 and the convertor gear 3 must be considered at the same time, because their properties are determined by each other. To make a flower gear 2, first divide the circle corresponding to the X-Y plane into an equal number of segments according to the design (FIG. 10c). As the segments rotate around the Y-axis, the hypothetical sphere is cut and primary flower gears 2 are formed (FIG. 8 and FIG. 9) and (FIG. 10d,e). As shown in figures (FIG. 10d,e), by dividing the circle into more segments, different flower gear 2 is produced, and the number of these segments is one of the design parameters. And the number of these segments determines the number of the teeth 8 of the main gear 1, in this way, the number of teeth 8 of the main gear 1 is equal the number of these segments. For instance, in (FIG. 8) there are eight 45-degree segments therefore, a main gear 1 with eight teeth is designed for these flower gears 2. In (FIG. 9), the circle is divided into sixteen sectors of 22.5-degree, and in this case, there would be two types of flower gear 2, and based on this, sixteen teeth should be designed for the main gear 1 as well. A certain number of identical grooves 6 are created inside the flower gear 2. Based on the application of the device, the number of these grooves 6 is another parameter of design of this device. For connecting to the output shafts and transmit the rotational force to them is designed one types of coupling for the flower gears 2. The edges for placement the necessary bearings should be considered in the body 4, in such a way that while maintain the position of the shafts, they can rotate smoothly.

Main gear 1 is the biggest slice of the hypothetical sphere that fits inside the flower gears 2 with the suitable distance for rotation of them. As mentioned, based on the design of the cutting sectors of the flower gears 2, the specified number of teeth 8 is installed in the surface of the main gear 1. For instance, eight teeth for sectors with 45 degree and sixteen teeth for sectors with 22.5 degree. In the center of the main gear 1 is considered an inner gear that engages with the convertor gear 3 and applies input motion force to the main gear 1. The diameter and the height of this inner gear is designed based on the deflection angle of the new plane to which the main gear 1 corresponds. These parameters are included in the design in such a way that while maintaining the position of the main gear 1 and its smooth rotation, it has a strong engagement with the convertor gear 3.

The convertor gear 3 is a long gear that apply the input motion force to the main gear 1, but due to existing the angle difference between the rotational axis of the main gear 1 and the rotational axis of the convertor gear 3, the important task of the convertor gear 3 is to eliminate that. The effective variables in the design of the convertor gear 3 are the diameter, height, the number of teeth and pitch of them. The convertor gear 3 is designed such a way so that by maintaining a strong engagement at points of the contact with inner gear of the main gear 1, it transmits the driving force of the input shaft to the main gear 1 and eliminates the difference in the angle of rotation of the main gear 1 compared to the input shaft. To achieve this, the diameter of the inner gear of the main gear 1 bigger than the diameter of the convertor gear 3 is considered so that the amount of deviation of the angle between the input shaft and the rotational axis of the main gear 1 are caused the teeth of both of them engaged to each other at the two points on the plane Y-Z.

To design and build the body 4 of this gearbox, it is necessary to consider a support for the main gear 1, which always maintains the angle of the main gear 1 with the plane X-Y. For maintaining the input shaft position that is correspond to the Z-axis, design a place to install bearings at the bottom and top. A place for the flower gears 2 to be located in the body 4 should be designed in accordance with the Y-axis. Due to the fact that when the components of the device are placed next to each other, the gearbox is almost in the shape of a sphere, so according to application of the gearbox, the body 4 of the gearbox is designed and built.

Gearbox Operation Process:

Through the input shaft, driving force is applied to the convertor gear 3 and rotates it. Due to existing two engagement points because of the angle difference between rotational shafts of the main gear 1 and convertor gear 3, the convertor gear rotates the inner gear of the main gear 1. The main gear 1, which has two points of engagement with each flower gear 2, rotates them. However, since the points of engagement of the flower gears 2 are opposite to each other with respect to the plane X-Y, their rotation will be in the same direction. By rotating the flower gears 2, the rotational force is applied by changing the direction and ratio to the output axes.

Ratio:

New Ideas Included in this Gearbox:
In this gearbox there are two flower gears that rotate in the same direction by one main gear 1, the idea for this mechanism is to use the difference rotational angle between the main gear and the flower gears. In this way, the angle difference between the rotational axis of the main gear and the input shaft causes the main gear to engage with each of the flower gears in the opposite side with respect to the plane X-Y. The engagement points of the main gear with the flower gears cause the flower gears rotate in the one direction by the main gear. The advantages of this idea are that because each flower gear has two engagement points in two sides of the rotational axis, rotational force is transmitted more stronger and more reliable than the similar devices with one engagement point.
The idea to design the components of this device such a way that when are located next to each other, they almost form a sphere. The advantages of this idea are that this device has less unused space, a balanced shape, a shape compact and practical than similar devices. As mentioned earlier in the section background of the invention these unique properties of this gearbox make it applicable in many cases, including the joints of robot limbs, as well as the joints of human artificial limbs.
The idea of using the convertor gear and the inner gear of the main gear to transmit the input force to the main gear whose shaft is diagonal to the input shaft. The advantages of this idea are that because the convertor gear has two engagement points with the inner gear of the main gear in two sides of the rotational axis, rotational force is transmitted more stronger and more reliable than the similar devices with one engagement point.
The idea of using two flower gears for transmit the rotational force into the output shaft is one other advantage of this device that makes more strong rotational engagement.

These new ideas are the principal factors in making, design and function of this gearbox. And by using effective variables in designing, different types of this gearbox with different shape, volume and applications are manufacturable. In this device the ratio is determined based on the following variables and the desired ratio can be obtained by combining the changes of these variable:
The diameter of the hypothetical sphere which is the basis of the design of the components.
The number of grooves 6 on the flower gears 2.
The cutter angle of shell of hypothetical sphere to create the flower gear 2.
The number teeth 8 of the main gear 1.
The deviation angle size between the rotational axis of the main gear and input shaft which is another basis of the design of this gearbox.
Diameter of the convertor gear and the inner gear of the main gear.
The number teeth 5 of the convertor gear and the inner gear of the main gear 1.
The pitch of the teeth 5 of the convertor gear and the inner gear of the main gear.
The length of the convertor gear 3.

Design to Get the Right Ratio:

As mentioned, based on the above variables, the ratio of the device is determined, which is considered in proportion to the function of the device, for example:

A hypothetical sphere with fifty millimeters diameter is considered for design the components of the gearbox. Consider 40 grooves 6 for the flower gear 2 so the angle between two grooves 6 will be nine degrees, this number is the difference angle between the main gear 1 plane and the plane X-Y also. Nine degrees is the difference angle between the rotational axis of the main gear 1 and the input shaft of the convertor gear 3 as well. To make the flower gears 2, determine at what angle the circle of the hypothetical sphere should be cut. By specifying the number of the sectors of cut, the number teeth 8 of the main gear 1 is also determined, because the number teeth 8 of main gear 1 is always obtained by this method. In this example the circle of the hypothetical sphere divided into eight 45-degree sector so the number teeth 8 of the main gear 1 is eight also. By rotating the determined sectors around the Y-axis and cut the shell of the hypothetical sphere the flower gears 2 are formed (FIG. 8). Eight teeth 8 are placed on the surface of the main gear 1, which is the biggest slice of the main hypothetical sphere (FIG. 1,2). The new plane corresponds to the center plane of the main gear 1 with an angle deviation from the X-Y plane, which intersects with the Y-axis at the coordinate center. In this example the teeth 8 of the main gear 1 are located on the surface of the main gear on the new plane with equal angle 45-degree. Based on the fact that all teeth 8 of the main gear 1 is on the same plane, the resulting ratio is obtained by dividing the number of teeth 8 of the main gear 1 by the number of the grooves 6 of the flower gear 2, that in this example, the ratio is 1 to 5.

So far, the ratio created is based on the placement of all the teeth 8 of the main gear 1 on one plane, which made the ratio equal to the product of dividing the number of the grooves 6 of the flower gear 2 by the number of the teeth 8 of the main gear 1. But by dividing the total angle between the two groove of the flower gear 2 between the teeth 8 of the main gear, the ratio increases, that is, if we divide the angle of 9 degree by 2 and take each tooth of the main gear 2.25 out of the center plane of the main gear, a total of 4.5 degrees between two teeth. And reduce the deflection angle by half, the resulting ratio will be doubled.

Of course, this example is only to describe the invention, and surely all methods, designs and calculations to build this gearbox suitable for a specific application by using these ideas are acceptable.

1: A globular right-angle gearbox, simultaneously changes the direction of the input force, the ratio of torque and speed and applies the rotational force with new direction and ratio based of the design to the output shafts and because its components are in the form of parts of a sphere a hypothetical sphere is considered for easier description and design of those:
to design of this gearbox, proportion to the application of the device is considered the hypothetical sphere with specified diameter (FIG. 10a);
this hypothetical sphere is only for the better visualization to describe the device and its components and their positions;
by considering this hypothetical sphere during the design time, the sizes and positioning of the components are designed better and more easily;
whole of the components, axes and planes of this device are in accordance with the coordinate system of the hypothetical sphere;
the hypothetical sphere has three axes X, Y and Z and three planes X-Y, X-Z and Y-Z (FIG. 10b);
there is another plane with a certain angle to the plane X-Y, which is called the new plane and perpendicular to this new plane there is an axis, which is called new axis here;
the input shaft corresponds to the Z-axis and the output shafts correspond to the Y axis;
the center plane of the main gear 1 corresponds to the new plane and the rotational axis of the main gear corresponds to the new axis;
when the components of the device are placed together, there is less empty and useless space than similar devices. In other words, this gearbox is a compact device;
the globular right-angle gearbox comprising:
the main gear 1 is in the form of biggest slice of a sphere;
center plane of the main gear coincides with the new plane,
rotational axis of the main gear corresponds to the new axis;
in the center of the main gear there is an inner gear;
the specific number of teeth 8 are placed on the surface of the main gear 1 with specific position so that the angles between them are equal, according to the design;
the flower gear 2 is in the form of part of shell of a sphere,
the rotational axes of the flower gears correspond to the Y axis;
inside of the flower gear a number of uniform grooves 6 is designed;
In this gearbox always, two flower gears 2 are used that are completely identical;
the convertor gear 3 is a long gear;
the rotational axis of the convertor gear corresponds to the Z axis;
the convertor gear is located inside the main gear 1 and has two engagement points with its inner gear which rotate the main gear 1;
the principal task of the convertor gear is to rotate the main gear 1 by the force exerted of the input shaft and the convertor gear 3 is required to eliminate the angle difference between the rotational axis of the main gear 1 and the axis of the input shaft;
the body 4 of device is in the form of a hollow sphere that maintains all of the components and axes in their designed positions;
when the components of the device are placed together, they almost form the shape of a sphere, and the body 4 which is in the shape of a hollow sphere, covers them.
new ideas and their advantages of the working mechanism of this device;
In this gearbox there are two flower gears that rotate in the same direction by one main gear 1, the idea for this mechanism is to use the angle difference between the rotational axis of the main gear and the input shaft,
the advantages of this idea are the main gear to engage with each of the flower gears in the opposite side with respect to the plane X-Y is that the rotational force is transmitted more stronger and more reliable;
the idea to design the components of this device such a way that when are located next to each other, they almost form a sphere;
the advantages of this idea are that this device has less unused space, a balanced shape, a shape compact and more practical than similar devices.
these unique properties of this gearbox make it applicable in many cases, including the joints of robot limbs, as well as the joints of human artificial limbs,
the idea of using the convertor gear and the inner gear of the main gear to transmit the input force to the main gear whose shaft is diagonal to the input shaft;
the advantages of this idea are that because the convertor gear has two engagement points with the inner gear of the main gear in two sides of the rotational axis, rotational force is transmitted more stronger and more reliable;
the idea of using two flower gears for transmit the rotational force into the output shaft is one other advantage of this device that rotational force is transmitted more stronger and more reliable than the similar devices,
the engagement points of the main gear with the flower gears cause the flower gears rotate in the one direction by the main gear;
The advantages of this idea are that because each flower gear has two engagement points in two sides of the rotational axis, rotational force is transmitted more stronger and more reliable;
use a diagonal rotational axis for the main gear 1, with this mechanism, the main gear 1 engages with the flower gears 2 in the opposite sides of each other from the plane X-Y, as a result of the rotation of the main gear 1, the input rotational force transmitted to the flower gears and they in their planes that are parallel with the plane X-Z rotate.
the globular right-angle gearbox operating process;
through the input shaft, driving force is applied to the convertor gear 3 and rotates it;
the convertor gear rotates the main gear, because of having two engagement points with the inner gear of the main gear;
the main gear rotates the flower gears, because of having two engagement points with each one;
the flower gears rotate in one direction because the engagement points of each one locates in the opposite side of the other one from the plane X-Y;
through the flower gears, rotational force with the new ratio according to the design, applied to the output shafts;

2: The globular right-angle gearbox of claim 1, wherein the main gear 1 is a new type of gear that rotates both flower gears 2 in the same direction although the rotational axis of the flower gears and the rotational axis of the input shaft have a ninety degrees angle difference;

3: The globular right-angle gearbox of claim 1, wherein the flower gear 2 is new type of gear with a number of uniform grooves 6 inside it, which has two engagement points with the main gear;

4: The globular right-angle gearbox of claim 1, wherein using two cylindrical gears the convertor gear and the inner gear of the main gear, inside each other with different diameters to correct the deflection angle of rotational axis of the main gear 1, the large cylinder with a diagonal axis touches the smaller cylinder on a plane perpendicular to the plane of the cylinders at both the top and bottom points. And this method causes the larger cylinder to rotate around its own diagonal axis as the smaller cylinder rotates.

5: The globular right-angle gearbox of claim 1, wherein using a rotation of the main gear 1 with a diagonal axis causes it to engage with [two] flower gears 2 on opposite sides of the X-Y plane, and this method causes both flower gears 2 rotate around their axes in the same direction.

6: The globular right-angle gearbox of claim 1, wherein designing of the components of this device is in the form of parts of a sphere in such a way that when they are placed together, a hollow sphere as a body, surrounds them, and this is one of its features that caused it is useful and applicable.

7: The globular right-angle gearbox of claim 1, wherein in this device the rotational axes rotate by two engagement points in two sides of their axes and this method caused the rotational force transmitted stronger and more reliable.
